(19) United States
(12) Patent Application Publication
(10) Pub. No.: US 2008/0255928 A1
(43) Pub. Date: Oct. 16, 2008

(54) TRUSTED NETWORKS OF UNIQUE IDENTIFIED NATURAL PERSONS

(76) Inventor: Thomas Joseph Tomeny, Frisco, TX (US)

Correspondence Address: Thomas Tomeny, 5202 Pueblo Lane, Frisco, TX, 75034, US

(21) Appl. No.: 12/098,489

(22) Filed: Apr. 7, 2008

Related U.S. Application Data
(60) Provisional application No. 60/922,670, filed on Apr. 10, 2007.

(51) Int. Cl. G06Q 30/00; H04L 9/32; H04L 9/00; G06Q 99/00; G06F 17/30

(52) U.S. Cl. 705/10; 726/5; 726/1; 707/104.1; 705/1; 705/26; 707/E17.005

(57) ABSTRACT

A secure trusted network of unique natural persons is formed by a configuration of natural person users, network gateways, and a network guardian. Users are allowed one registration per lifetime, and therefore have durable reputations on a secure trusted network. With all users having durable reputations, interactions on a secure trusted network are robust and reliable in comparison to less trusted and secure networks. Network gateways allow users to interact with other networks while protecting their data stream and provisioning identity information as may be required.

This application claims the benefit of U.S. Provisional Application No. 60/922,670 filed on Apr. 10, 2007, entitled Trusted Networks of Unique Identified Natural Persons, which application is hereby incorporated herein by reference.

### TECHNICAL FIELD

The present disclosure relates generally to information networks and, in particular, to systems and methods for securely accessing such networks.

### BACKGROUND

Conventional information networks are continually dealing with security issues from both authorized and unauthorized users. Many conventional networks provide unfiltered access to most network resources by any network node. Secure areas of networks are typically secured by identification and authentication schemes that are often inadequate. Additionally, many networks do not have adequate provisions to prevent single individuals from assuming multiple identities on the network, both simultaneously and over time. Conventional networks are thus vulnerable to security breaches that could affect all users of the network.

There is therefore a need for improved systems and methods for structuring and accessing an information network.

### SUMMARY

The present disclosure provides systems and methods for structuring and accessing an information network.

In one embodiment, the present disclosure provides a method for providing secure and unique access to a trusted data network. The method could include receiving an identifier associated uniquely with a user and providing an authentication uniquely associated with the user. The method could also include, in response to the authentication, providing the user secure access to a physical or virtual trusted network gateway providing filtered and secure access to the trusted data network, wherein the network gateway isolates the user from gaining access to the trusted data network directly.

In another embodiment, the present disclosure provides a filtered and secured virtual trusted data network. The network could include a physical or virtual trusted network gateways associated with a user or multiple users. The network could also include a trusted network guardian associated with the trusted network gateways. The trusted network guardian's primary role is to insure the uniqueness of each and every user, both simultaneously and across time. The trusted network guardian also has responsibility for governing the trusted data network.

Other technical features may be readily apparent to one skilled in the art from the following figures, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 is an illustration of a conventional data network, with a single user accessing with multiple identities;

FIG. 2 depicts a conventional data network with a single virtual private network connection;

FIG. 3 is an exemplary trusted network of unique identified natural persons overlaying a conventional network;

FIG. 4 is an exemplary trusted network of unique identified natural persons that utilizes physical rather than virtual connections between trusted network gateways and users;

FIG. 5 is a somewhat simplified flow diagram illustrating a method of providing secured access to a trusted data network according to one embodiment of the present disclosure.

### DETAILED DESCRIPTION

The present disclosure provides for a trusted network guardian and trusted network gateways for the network.

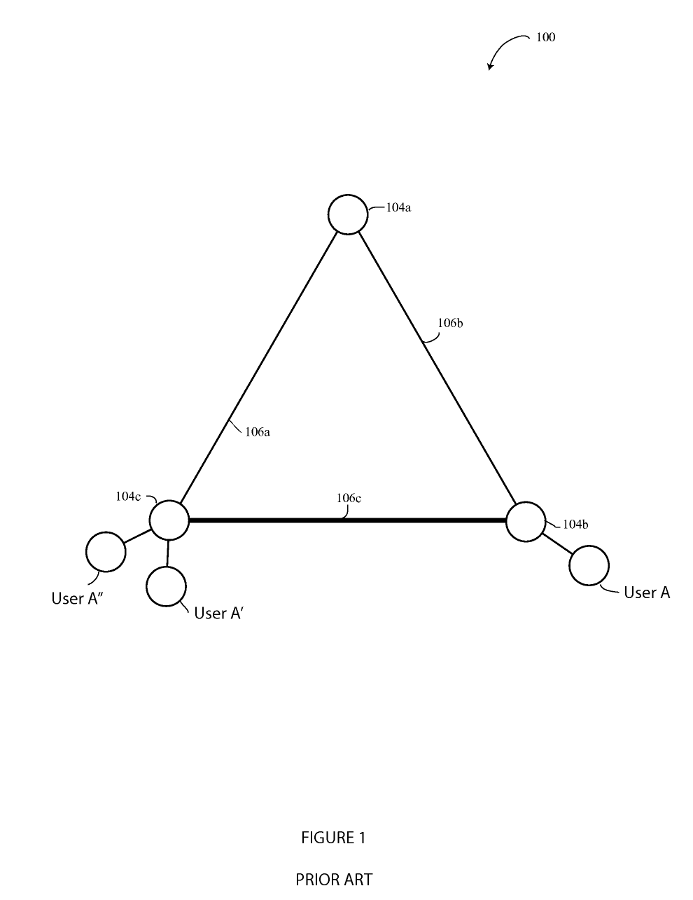

FIG. 1 generally illustrates a conventional Internet network structure 100 having nodes 104a, 104b and 104c, (sometimes collectively referred to herein as interconnect nodes 104). The embodiment of network structure 100 shown in FIG. 1 is for illustration purposes only and is not drawn to scale.

Interconnect nodes 104 are connected to other interconnect nodes 104 by at least one path, for example, paths 106a, 106b, and 106c (sometimes collectively referred to herein as paths 106) as shown in FIG. 1. Although network structure 100 could have many paths 106, a relatively few number of paths 106 could be characterized as a secure paths. For example, for network structure 100, path 106c could be the only secured path in network structure 100 and is illustrated as a bold line in FIG. 1. Paths 106a and 106b are not secured paths and are illustrated with a normal line in FIG. 1. Accordingly, network structure 100 provides a very limited number of secured paths between interconnect nodes 104 and thus could be severely impaired should a security breach or other network violation occur anywhere in network structure 100. Users connect at any node where they have permission or are otherwise able to gain access. Users may connect at many nodes, including simultaneously, and use multiple identities to engage in undesirable activities. A single User A is illustrated with three simultaneous connections at different interconnect nodes- User A at node 104b, User A′ at node 104c, and User A″, also at node 104c. Data typically flows freely and unexamined through the interconnect nodes in both directions, leaving users vulnerable to malicious data from the network and the network vulnerable from malicious data from the users.

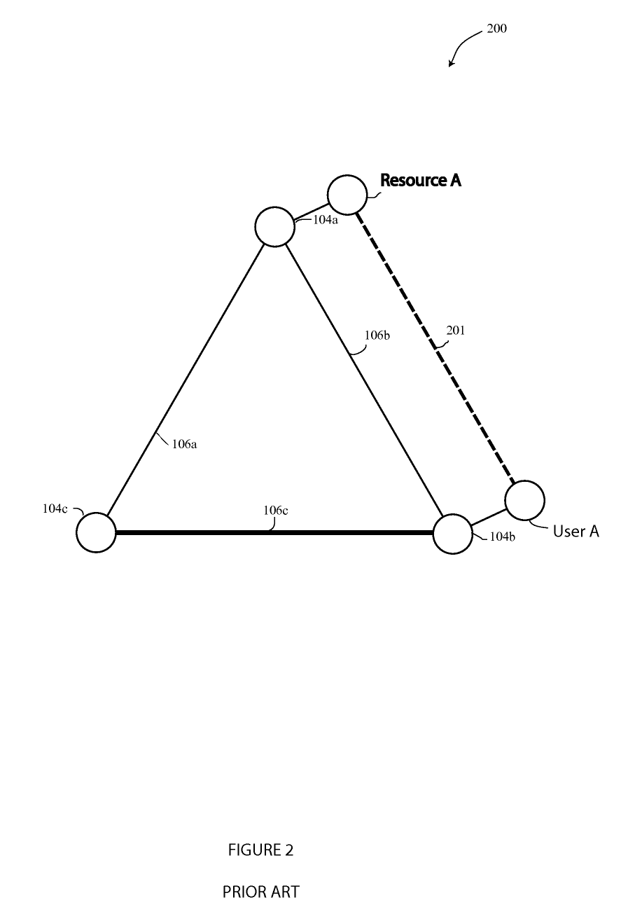

FIG. 2 illustrates network 200 in accordance with one embodiment of the present disclosure. Network 200 includes the same basic network structure as FIG. 1 and includes the existing technology of a virtual private network, illustrated by connection 201 between User A and Resource A. The virtual connection between User A and Resource A is relatively secure, even though the physical connection between each and the underlying network may be less secure. Software enables the virtual private network arrangement to provide much more security.

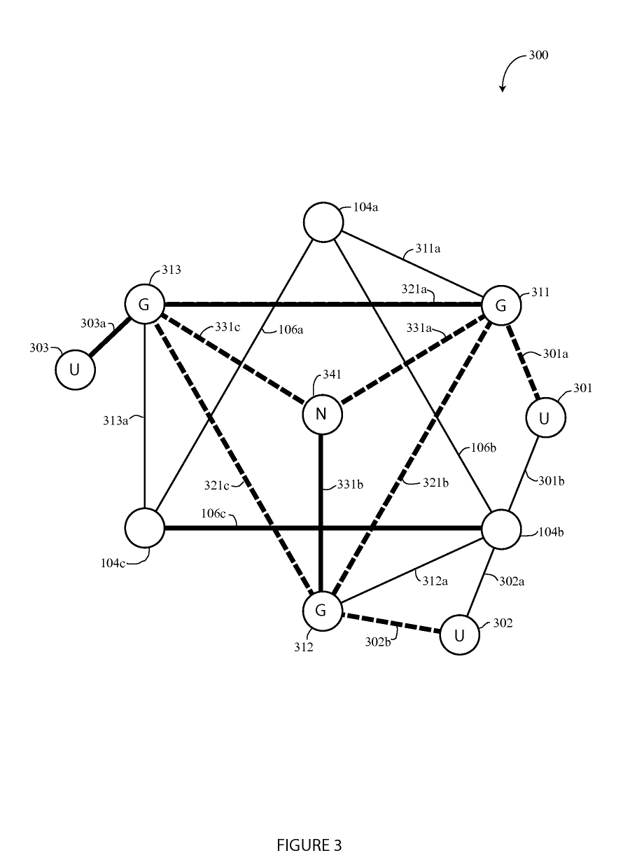

In the exemplary embodiment 300 shown in FIG. 3, there are two interconnected networks, the conventional network comprised of nodes 104 and the connections between them 106a, 106b, and 106c, and the trusted network comprised of the sole network guardian 341, three trusted network gateways 311, 312, and 313, and the connections between them, 321a, 321b, 321c, 331a, 331b, and 331c. The conventions of FIG. 3 are that regular weight lines represent relatively insecure connections while bold lines represent relatively secure connections. Solid lines represent physical connections while dashed lines represent virtual connections similar to 201 in FIG. 2. Ordinary network interconnection nodes have no identifying letter while the sole trusted network guardian 341 is indicated by “N” and each of the three trusted network gateways is indicated by “G” and each user is indicated by “U”.

The trusted network 300 as illustrated in FIG. 3 is an overlay of the conventional network. Each node of the trusted network has at least one physical connection to the conventional network. For instance, user 303 has a physical connection to trusted network gateway 313 which in turn has a physical connection to conventional network interconnect 104c. Likewise, trusted network guardian 341 has a physical connection to the conventional network through connection 331b, trusted network gateway 312, connection 312a, and interconnect 104b. Physical connections in this disclosure include any and all kinds of wireless data connections. Using the same systems and methods of this disclosure, a trusted network of unique identified individuals may also be created without an underlying conventional data network.

The primary role of the trusted network guardian 341 is to insure that each user of the trusted network is a unique natural person, both at each instant and over time, and to insure that each trusted network gateway only allows users and data that comply with the trust standards of the trusted network. In one embodiment, the network guardian may not have a physical presence on network 300 but could be, for example, an integral part of the distributed processing and storage capacity provided by the trusted network gateways. The trusted network guardian has access to identifying data on users beyond the span of their natural lives, so that a user may not use the trusted network with one identity at one time and use the trusted network again at another or the same time with a different identity.

The trusted network guardian may be a natural person, partnership, corporation, or any sort of non-personal entity. If the trusted network guardian is anything other than a natural person, it will be represented on the trusted network by duly authorized natural persons who are themselves authorized as users of the trusted network. For the purposes of this disclosure, “trusted network guardian”, “network guardian”, and “guardian” each mean the totality of that entity, including physical and virtual assets and employees, partners, and directors.

The primary role of the trusted network gateways is to identify and authenticate users, and to filter the data going to users and coming from users according to the established trusted network trust standards. Each trusted network gateway is responsible for all of the data that is placed on the trusted network by its users and itself. The trusted network gateways are responsible for making sure that each of their own users is a unique natural person and corresponding with the trusted network guardian to insure that each user is unique on the network at any point in time. Data from the conventional network flowing through the trusted network gateway may be handled and filtered differently than data from the trusted network due to the less secure nature of the conventional network.

A trusted network gateway may be a natural person, partnership, corporation, or any sort of non-personal entity. If a trusted network gateway is anything other than a natural person, it will be represented on the trusted network by duly authorized natural persons who are themselves authorized as users of the trusted network. For the purposes of this disclosure, “trusted network gateway”, “network gateway”, and “gateway” each mean the totality of that entity, including physical and virtual assets and employees, partners, and directors.

Users may access the trusted network in several ways. User 301 in FIG. 3 has a relatively insecure physical connection 301b with conventional network interconnect 104b. After establishing that connection, user 301 navigated to an identification and authentication site in order to establish relatively secure virtual connection 301a with trusted network gateway 311 which itself has a relatively insecure physical connection with interconnect 104a by connection 311a. Similarly, user 302 began with a physical connection 302a to interconnect 104b before identifying and authenticating to form connection 302b with trusted network guardian 312 that has its physical connection 312a to the conventional network at the same interconnect 104b as user 302. User 303 has its physical connection directly with trusted network gateway 313. This does not simplify access for user 303 because while the device may have a physical connection to the trusted network gateway, only identified and authenticated individuals may access the trusted network beyond the gateway. Users may access the trusted network from different trusted network gateways at different times, but may not access the trusted network from more than one trusted network gateway at one time.

The trusted network portion of the overall network may be virtual or physical or a combination thereof. In FIG. 3, the single network guardian is illustrated with a secure physical connection to trusted network gateway 312 on line 331b and secure virtual connections to trusted network gateways 311 and 312 on line 331a and 331c. Similarly, trusted network gateways 311 and 313 are illustrated connected to trusted network gateway 312 with secure virtual connections 321b and 321c while being connected to each other with secure physical connection 321a.

While only three trusted network gateways and three users are illustrated in FIG. 3, this disclosure includes any number of trusted network gateways and any number of users of each trusted network gateway and of the trusted network. The sole authority of the trusted network guardian is an essential component of the disclosure, though the duties of the trusted network guardian may be distributed across the trusted network and the trusted network guardian may appear to have multiple identities and locations for multiple purposes.

The embodiment of network 300 shown in FIG. 3 is for illustration purposes only and is not drawn to scale. Other embodiments of network 300 could be used without departing from the scope of this disclosure. Also, network 300 could be used in conjunction with any suitable application or system such as, for example, any suitable data information network, the Internet or an Intranet.

For the purposes of this disclosure, a user is a unique natural person utilizing a a device or devices that are physically or wirelessly connected to a conventional data network, though that data network may be operated by the trusted network. Once a user has identified and authenticated for a session with a network gateway, the network gateway may provide identity information for the user to other parties both on the trusted network and the conventional network. Provisioning of user identity information may be according to the parameters agreed to by the trusted network gateway and the user from time to time. The network guardian may also provide anonymity or a false identity for the user to both the conventional and trusted networks. Generally, anonymous and false identities will only be allowed on the trusted network if they are disclosed and appropriate to the particular interaction. It is anticipated that the network gateway will retain true identity information for all interactions involving anonymous or false identities on the trusted network.

A trusted network of unique natural persons like network 300 illustrated in FIG. 3 only allows individuals to register as users rather than as corporations or other entities. Corporations and other non-personal entities may use network 300 by having individual employees use network 300. Individuals may have employment information and authority as part of their identity attributes. If an individual is certified as a representative of a corporation or other non-personal entity by other individuals with the appropriate employment and authority identity attributes, they may represent themselves across the network as such.

In one embodiment, one or more selected trusted network gateways could grant rights to all users associated with that particular trusted network gateway. For example, suppose a user associated with trusted network gateway 311 wishes to gain access to network 300. Trusted network gateway 311 may grant similar or identical access and corresponding rights to that particular user as it would with any user associated with that trusted network gateway 311.

Generally, each of trusted network gateways has a secure connection with each other, either directly or indirectly. After a user has been identified and authenticated, each of trusted network gateways have secure connections with each user associated with that particular trusted network gateway. Similarly, each of trusted network gateways has a secure connection with network guardian 341. As an example, user 303 could be associated with trusted network gateway 313. After user 303 has been identified and authenticated by trusted network gateway 313, user 303 has a secure connection with each user associated with trusted network gateway 313. In addition, trusted network gateway 313 will have a secure connection with all other trusted network gateways such as, for example, trusted network gateways 312 and 311, and with network guardian 341. The effect is that all trusted network users have secure connections with all other trusted network users. These connections are additionally filtered at both ends by their respective or same trusted network gateways. In one embodiment, each of trusted network gateways could also have secure and non-secure connections to other networks and resources.

In one embodiment, a user must have registered and chosen a particular trusted network gateway to be associated with in order to become securely connected and to gain access to network 300. For example, to obtain the benefits of a trusted network of unique natural persons such as, for example, network 300, a user selects one of the associated network gateways. Trusted network gateways may be chosen based on geographical location, functionality, cost concerns and/or some other suitable characteristics. Trusted network gateways could primarily compete with one another for users by being the most trusted, by having an established track record of never compromising users identities or data. Users may register with and use multiple trusted network gateways but may not do so in such a manner that allows them engage in activities that violate the standards of the trusted network.

After choosing a particular trusted network gateway, the user undergoes a registration process with that trusted network gateway. For example, the registration process could include providing at least some form of mutually acceptable identification and authentication information. In one embodiment, the registration process may be a face-to-face registration. Such registration may occur at a location associated with the trusted network gateway such as, for example, a local government agency, a private agency, a bank branch, a public utility, a school, a public library, a grocery store or any other suitable location. Alternatively, in one embodiment, registration could be possible through some form of electronic registration with verification and thus not requiring a face-to-face interaction.

In one embodiment, the registration process could also include using one or more unique identifiers to identify the user. For example, a user could use their birth coordinates or a specially selected password or series of passwords. The identifier could employ fingerprinting analysis, retinal eye scans, facial recognition techniques, other biometric data and/or related user identifications (IDs) and password schemes. Users may be catalogued and verified by the network guardian using genealogical data. The identifier could also use other systems and methods of identifying and authenticating a user associated with a trusted network gateway such as systems employing a series of actions by the user in response to templates presented by the trusted network gateway. Regardless of the system and method employed to identify the user, the registration process ultimately ensures that there is one and only one user associated with a particular user identity on network 300 and that each unique natural person has only one real identity on the trusted network during their lifetime.

After establishing a mutually acceptable identification and authentication procedure, the registration process could continue with an optional mutually acceptable service agreement. Once registered, the user uses a relatively insecure connection to attempt to connect to its chosen trusted network gateway. The user engages with its trusted network gateway and undergoes an identification and authentication process according to the procedure set up during the registration process. After the identification and authentication processes are completed, including verification with the trusted network guardian that the user is unique, the trusted network gateway supplies a secure virtual or physical connection to the user to provide access to network 300 and also filters data from both the secure trusted portion of the network and the conventional network. The trusted network gateway could be a secure single sign on point for the user by provisioning user identity information to other parties and acting as proxy in some interactions as per parameters agreed on by the user. As seen in FIG. 3, user 302 is associated with trusted network gateway 312 and, when using its secure connection with 312, is isolated from the conventional network. Thus, security issues associated with conventional networks such as, for example, network 100 shown in FIG. 1, are greatly reduced.

A user could choose particular qualities associated with its trusted network gateway according to one embodiment of the present disclosure. Trusted network gateway 312 could use its relationship with the user to customize the user's network experience as per the mutually agreed parameters sought after and agreed to during the registration process described earlier herein. For example, when trusted network gateway 312 services a user, trusted network gateway 312 may employ software or people to analyze the most common activities of the user, and suggest other activities the user may desire. The trusted network gateway may customize interfaces for particular users based upon there patterns of use. In one example, instead of a user designating favorites as is conventionally done in browsers and third party sites now, the trusted network gateway recognizes certain sites as favorites after a few visits and automatically creates a short cut to those sites and automatically transmits identity information when the short cut is chosen. This comprehensive system is not possible on a conventional network because there is no single entity with comprehensive data to automatically create the customized experience and many users use multiple devices.

In one embodiment, the present disclosure could force users to be held responsible for their own actions. Users that abuse network 300 may be fined, suspended, or permanently terminated from network 300 by their respective trusted network gateway or the network guardian. Accordingly, minors and other potentially irresponsible users could only access network 300 through an arrangement with a responsible user. Sponsored accounts could be opened by responsible users for the benefit of their designees as long as the responsible user takes full responsibility for the actions of the designees. Sponsored users may be identified as such on the trusted network. In addition, temporary keys may be issued to third party users to temporarily access parts of network 300 under the authority and responsibility of a registered user. For example, a registered user could grant a doctor access to the medical records portion of the user's files maintained by the user's trusted network gateway. Any activity using such keys may be monitored by network 300 with heightened security criteria in place.

Network 300, in one embodiment of the present disclosure, could be a part of or could work in conjunction with existing information networks such as, the Internet. One of more individuals or firms could begin offering a secure virtual or physical connection to the Internet while maintaining each user's identity information with an individual or firm acting as network guardian 341. As the number of users and trusted network gateways increase, network 300 will begin to form a larger complement of secure connections with one another.

In one embodiment, network 300 provides a secured or trusted network that helps to eliminate problems that are prevalent in conventional data systems such as, for example, the unsecured Internet. As an example, all information could be connected to the individual who created or received it and those actions may be curtailed by the trusted network gateways, the network guardian, or other appropriate network entities or authorities. For example, activities such as spamming, phishing, sock puppetry (dominating arguments by using false multiple identities), predatory chats, intellectual property theft, identity theft, minors or other individuals viewing inappropriate content and click frauds may be curtailed and monitored efficiently. Since the trusted network gateways have intimate knowledge of each user's activities, they may also use out of character activities as an additional security feature.

As network 300 expands so that more content originates at trusted sources, network 300 will be comparatively easier for each trusted network gateway to screen content per each user's parameters designated during registration or specified anytime thereafter in the normal course of business. Accordingly, as more content originates from a new trusted network, such as network 300, than from existing insecure networks, such at existing Internet systems, network 300 could globally filter unwanted content such as, for example, pornography or phishing web sites. Alternatively, unwanted content could be allowed, but labeled as such with the use of tags or other identifiers.

In one embodiment, the trusted network gateway could track a user's repetitive tasks or inputs and anticipate and/or substitute other actions to reduce or eliminate the repetitive actions.

In one embodiment, by tracking the activities of the user, the trusted network gateway can, at the user's option, provide context sensitive and customized advertising and features. For example, trusted network gateway could find that a user inputs a long URL frequently. The trusted network gateway could provide a shortcut URL or a single word or button to the user as an alternative. As another example, the trusted network gateway could provide particular audiences for paying advertisers based on users' tracked activities. Thus, trusted network gateways can provide valuable intellectual asset assessments and marketing results to paid advertisers while simultaneously protecting the actual identities of the users that the advertisers wish to reach as the trusted network gateway can transmit the marketing communication to its users without identifying the users to the advertiser. The existing common advertising scheme of pay per click on the existing Internet could be replaced by a reliable pay per action or transaction system on a trusted network of unique identified natural persons since the trusted network gateway would likely have access to sufficient data to determine if a transaction was completed between an advertiser and a user.

In another embodiment, trusted network gateways, which may store a wealth of data on their users as they monitor their data flows, may offer credit histories to third parties and credit to their users. Point of sale devices with secure access to a trusted network gateway could replace physical credit and debit cards and other physical payment objects. Users may use their regular method of identification and authentication on the trusted network to authorize payment or may have different methods of identification and authorization connected specifically to using the trusted network for payment purposes.

In another embodiment, the trusted network may be used to facilitate downloading and payment for intellectual property. Since all the data will be downloaded through a trusted network gateway, rights holders of intellectual property could contract with trusted network gateways to insure that they receive payment for downloaded property.

In another embodiment, trusted network gateways could offer proprietary or non-proprietary application sets according to the user's habits or preferences. Such applications could be provided for all common computing tasks such as word processing, video, graphics, and data analysis. The processing load could be shared between the user's device and the network. While similar systems are becoming and available on conventional networks, they lack sufficient security for widespread use when the data is sensitive. On a trusted network of unique identified natural persons with the network gateways competing to be the most trustworthy and to be the most secure, the design of the network and the competition could lead to a network of unparalleled security that will be trusted with even the most sensitive data by its users.

In one embodiment, the present disclosure provides a life history accounting of a user. In network 300, users could own their own data file maintained on the network by their trusted network gateway. A user data file could contain interaction receipts detailing some or all interactions that the user has through the network gateway. A separate interaction receipt could be generated for every party to an interaction and stored by each user's trusted network gateway. Receipts could be classified by class, time, and identity status including private, anonymously public, and real identity public. This life history accounting system maintained on the network imposes a uniform data structure on user data and can function as an extension of the user's physical memory, since the data resides on the network and is available from any physical location. Portions of data in the life history account could be shared or allowed to be appended by third parties designated by the user with the appropriate authorizations and identity safeguards. The receipt and life history accounting system could allow the trusted network gateway entity to be a proxy for its users in regards to ownership of assets and liabilities. This type of data arrangement is currently unavailable on conventional networks because data does not flow to and from users from a single controlled and secure access point.

In one embodiment, the present disclosure provides for a system and method of tagging and rating content and tags and ratings on a trusted network of unique identified individuals. User could tag and rate the tags of content as it is placed on the network. For example, a video that is represented to be about historical Mayan pottery might be tagged as history (80), Mayan (100), and pottery (90). Other users who view the video could then rate the tags and the ratings on the tags, so perhaps the user tags and ratings would end up significantly different than the original content provider's. In this example, the users tags might cumulatively be pornography (97), and time waster (99). Search engines on the trusted network could be optimized to not return results where the provider tags and ratings are substantially different than users tags and ratings. The users could also tag and rate the provider personally and the provider could tag and rate the users personally. This system imposes order on the content as it is introduced to the network and provides a basis for more relevant search results. Searches could explicitly search for content with tags and ratings within certain ranges. Tags could include more structured schemas such as Who, What, Where, Why, When, and How for each content item. This tagging and rating system could work successfully on a trusted network of uniquely identified users because every user is a known entity and they each have a reputation to protect. Existing conventional networks are very limited in deploying this sort of system because many of the users are anonymous or duplicate.

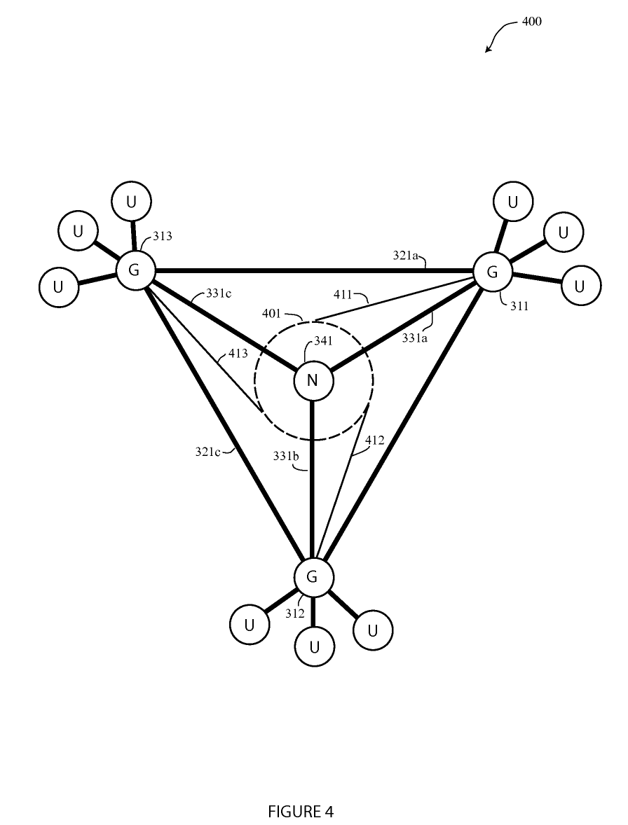

Referring now to FIG. 4, network 400 is an exemplary version of a trusted network of unique identified natural persons, where, in contrast to network 300, the trusted network gateways 311, 312, and 313 all have secure physical connections with their respective users and the network guardian 341. In this embodiment, each user is completely isolated from the insecure, non-trusted conventional network, which is represented by the dashed sphere labeled 401. Users may still access the resources of the conventional network, but all the data in this embodiment flows through the trusted network gateways and their connections to the conventional network 411, 412, and 413. This topology could represent the most secure and most trusted version of such a trusted network.

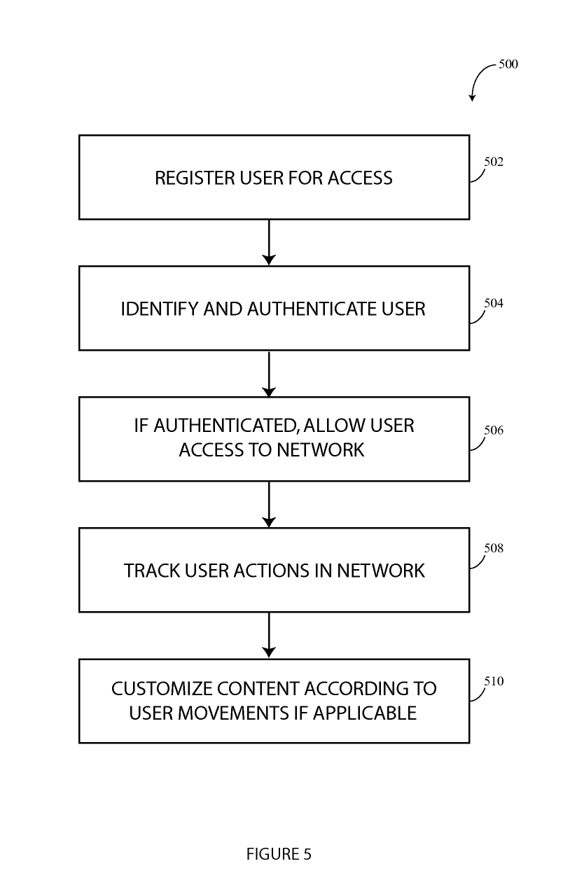

Referring now to FIG. 5, in one embodiment the present disclosure provides method 500 for providing secure connections to a shared data network such as, for example, the Internet or an Intranet. In step 502, a user registers a unique identifier and authenticator with trusted network gateway such as, for example, trusted network gateway 311, associated with the trusted network including the network guardian 341. Once registration is complete, the user need not repeat the registration process unless there is a specific need to so such as, for example, a security breach or network upgrades requiring re-registration.

After registration is complete and authenticated by trusted network gateway 311, the user may connect to network 300 in step 504. Network guardian 341 may additionally assess the user's identity for uniqueness. Trusted network gateway 311 identifies and authenticates the user while corresponding with the network guardian 341 to insure uniqueness and then the user is provided with access to network 300 in step 506. Otherwise, the user is notified that the identifying information is incorrect and could be prompted to enter the identifying information again in step 504. Accordingly, method 500 provides a user with access to a trusted network of unique identified natural persons. In step 508, network 300 and more particularly, the user's network gateway 311 could track a user's movements and/or actions within network 300. Trusted network gateway 311 begins to customize content on network 300 according to the user's movements and/or actions within network 300 in step 510. Method 500 continues and/or repeats as is necessary to optimize the user's experiences on network 300.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A method for providing a secure trusted network of unique natural persons with one lifetime registration on that network, the method comprising:
network gateways, that register and authenticate users, and isolate their data traffic when connected; and
a single network guardian, that insures each user is a unique natural person with a lifetime registration on the network so that each user has a durable reputation on the network; and
interconnections between users, gateways, and the network guardian arranged so that users are isolated, the gateways are peers, and the network guardian may administer the network.

2. The method of claim 1, further comprising a secure trusted virtual network.

3. The method of claim 1, further comprising a secure trusted physical network.

4. The method of claim 1, further comprising a secure trusted wireless network.

5. The method of claim 1, further comprising a secure trusted combination virtual, wireless, and physical network in any combination of those three.

6. The method of claim 1, further comprising data filtering by the network gateway so that the gateway simultaneously protects unique identified users and learns their preferences

7. The method of claim 1, further comprising provisioning unique identified user identities across a secure trusted network and other connected data networks that includes unique identified users using their real identities, partial identity information, false identities, and anonymity as per the users wishes and the requirements of third parties.

8. The method of claim 1, further comprising allowing unique identified users to use multiple devices, optionally simultaneously, on a secure trusted network.

9. The method of claim 1, further comprising of allowing minors and other non-fully responsible individuals to use a secure trusted network through the sponsorship of a unique identified user.

10. The method of claim 1, further comprising allowing temporary access to a unique identified user's data file on a gateway or guardian server as per the user's request and third party requirements.

11. The method of claim 1, further comprising a network gateway enhancing security by monitoring each unique identified user's traffic for out of character behavior.

12. The method of claim 1, further comprising globally filtering undesirable content on a secure trusted network by the network gateways sharing information on undesirable content with each other and the network guardian

13. The method of claim 1, further comprising reducing repetitive actions by unique identified users of a secure trusted network by the network gateways learning and anticipating user actions based on historical patterns.

14. The method of claim 1, further comprising offering advertising and marketing services by the network gateways based upon their intimate knowledge of not only past user actions, but ability to track future user actions, allowing network gateways to target ads precisely and charge marketers based upon actual purchases made by unique identified users of a secure trusted network

15. The method of claim 1, further comprising collecting and organizing unique identified user's data so that they may have as much as a lifetime of data available on a secure trusted network

16. The method of claim 1, further comprising replacing physical identity and credit cards with verifying identity and credit through a secure trusted network for its unique identified users.

17. The method of claim 1, further comprising allowing intellectual property to be bought and sold over a secure trusted network between unique identified users with the transaction, and potentially use, of the intellectual property monitored by the network gateways and guardian.

18. The method of claim 1, further comprising providing common computing applications to unique identified users of a secure trusted network within the secure space of the network.

19. A method of organizing content on a network with unique identified users with durable reputations, the method comprising:
tagging of content, tags, categorized ratings, and users; and
rating of tagging of content, tags, categorized ratings, and users; and
using the categorized ratings and tags to organize the data for network users.
